(19) United States
(12) Patent Application Publication
(10) Pub. No.: US 2009/0045249 A1
(43) Pub. Date: Feb. 19, 2009

(54) Modifying processing of scanned sheets based on scanned control sheets

(76) Inventors: Kohji Miyasake, Kanagawa-ken (JP); Kazuto Yamafuji, Kanagawa-ken (JP)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/840,983

(22) Filed: Aug. 19, 2007

(51) Int. Cl. G06F 17/00

(52) U.S. Cl. 235/375

(57) ABSTRACT

Scanned sheet processing is modified based on control sheets that are also scanned. The following is performed for each sheet of a number of sheets. The sheet is scanned, and whether the sheet is a control sheet is determined. Where the sheet is a control sheet, one or more of current settings governing processing of subsequently scanned sheets are modified based on the control sheet. For example, the current settings may be saved for later retrieval and the current settings modified. As another example, the current settings are to be reverted back to the saved settings previously saved. As two more examples, subsequently scanned sheets may be indicated as to be printed or faxed. Where the sheet is not a control sheet, the sheet is processed in accordance with the current settings. Such processing can include printing and faxing, among other types of actions.

### FIELD OF THE INVENTION

The present invention relates generally to modifying how scanned physical sheets are processed, and more particularly to modifying how such scanned sheets are processed based on control sheets that are also scanned.

### BACKGROUND OF THE INVENTION

Multiple-function devices (MFD's), which are also known as all-in-one devices (AIO's), are devices that can perform a number of different types of functionality. Typically, such devices include printing functionality and scanning functionality. They may also include faxing functionality. Thus, a user can scan a number of printed sheets for immediate printing thereof, which is known as copying. The user may also be able to scan the sheets to save an electronic version of them on his or her computer, and/or may be able to scan the sheets to have them faxed. The user can also use such an MFD as a standard printing device, to print data generated using his or her computer.

Within multiple-user environments, such as office environments, MFD's may become heavily utilized. As such, a number of issues can result. A first user may be in the process of scanning a large number of sheets for copying purposes. A second user may want to scan his or her own sheets, for copying or fax purposes. However, with traditional MFD's, the second user has to wait until the first user is completely finished before he or she can even place his or her sheets on or within the MFD in question. For instance, if the second user just places his or her sheets at the end of the first user's sheets, the MFD will likely process the second user's sheets as if they were part of the same job as the first user's sheets.

For these and other reasons, there is a need for the present invention.

### SUMMARY OF THE INVENTION

The present invention relates to modifying the processing of scanned sheets based on control sheets that are also scanned. A method of one embodiment sets current settings governing processing of sheets that have been placed in a scanning input of a device having at least scanning functionality and printing functionality. For each sheet that has been placed in the scanning input, in order in which the sheets have been placed in the scanning input, the following is performed. The sheet is scanned to yield an electronic version of the sheet. It is determined whether the sheet is a control sheet, based on the electronic version of the sheet.

Where the sheet is a control sheet, the method changes one or more of the current settings based on contents of the electronic version of the control sheet. Such changing can include performing one or more of the following actions. First, it can be indicated that electronic versions of subsequently scanned non-control sheets are to be printed. Second, it can be indicated that the electronic versions of the subsequently scanned non-control sheets are to be faxed to a fax number specified by the contents of the electronic version of the control sheet. Third, it can be indicated that the current settings are to be saved as saved settings for later retrieval and that the subsequently scanned non-control sheets are to be processed in accordance with changed settings specified by the contents of the electronic version of the control sheet. Fourth, it can be indicated that the current settings are to be reverted back to the saved settings previously saved and that the subsequently scanned non-control sheets are to be processed in accordance with the saved settings previously saved.

Where the sheet is not a control sheet, the sheet is processed accordance with the current settings, based on the electronic version of the sheet. Such processing can include performing one or more of the following actions. The electronic version of the sheet may be printed. The electronic version of the sheet may be faxed. The electronic version of the sheet may be stored within an electronic file on a storage device. A recordable data storage medium of one embodiment, such as a hard disk drive, an optical disc, a memory, and so on, may have one or more computer programs stored thereon to perform at least some parts of the method that has been described.

It is noted that until the order in which the sheets are placed on the scanning input can be changed at any time prior to the scanning of the sheets. For example, a first set of sheets may be placed in the scanning input first. Later, a second set of sheets may be placed in the scanning input after the last sheet of the first set. As another example, a first set of sheets may be placed in the scanning input first. Later, a second set of sheets may be placed in the scanning input, but in-between two sheets of the first set of sheets. In both examples, the second set of sheets may be placed in the scanning input after at least one sheet of the first set of sheets has already been scanned. Furthermore, the user placing the second set of sheets does not have to wait for the first set of sheets to be completely scanned before placing the second sheet of sheets on the scanning input, which is advantageous because this means that this user does not have to wait for the job encompassing the first set of sheets to have finished.

A device of an embodiment of the invention can include a scanning mechanism, a printing mechanism, a faxing mechanism, and a controller. The controller performs the following for each sheet that is scanned by the scanning mechanism. It determines whether the sheet is a control sheet, based on an electronic version of the sheet. Where the sheet is a control sheet, it changes one or more current settings governing processing of scanned sheets, based on contents of the electronic version of the control sheet. Such changing may be achieved as has been described above in relation to the method. Where the sheet is not a control sheet, the controller processes the sheet in accordance with the current settings governing processing of scanned sheets, as may have been changed based on previously scanned control sheets. Such processing may be achieved as has been described above in relation to the method.

Still other aspects, advantages, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method for processing scanned sheets by using scanned control sheets, according to an embodiment of the invention.

FIGS. 2, 3A, 3B, 4A, 4B, 5A, 5B, 6, 7A, and 7B are diagrams illustratively depicting examples of performance of the method of FIG. 1 in various scenarios, according to different embodiments of the invention.

FIG. 8 is a block diagram of a device, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

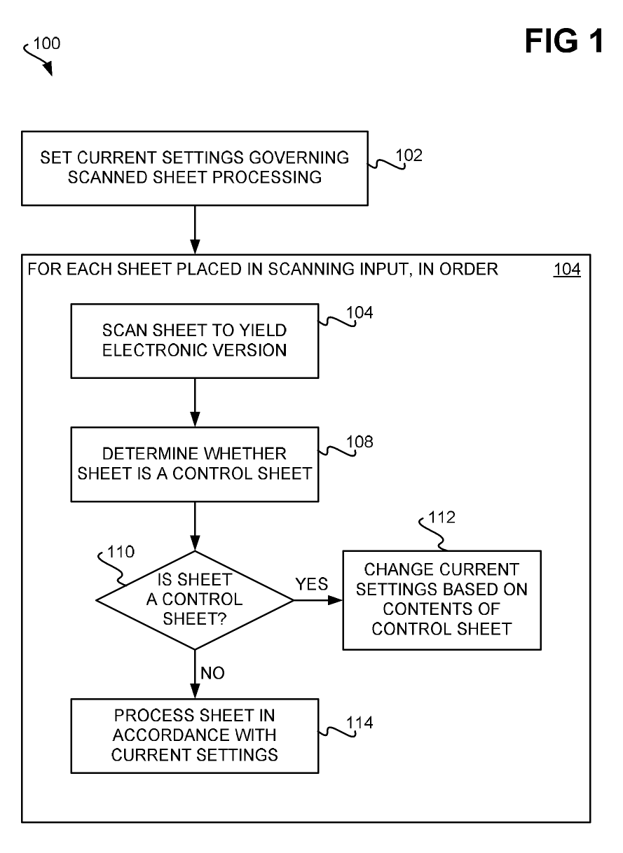

FIG. 1 shows a method 100 for processing scanned sheets by using scanned control sheets, according to an embodiment of the invention. The method 100 is performed in relation to a number of physical sheets that have been placed in a scanning input of a device. The scanning input may be a tray, a scanner hopper, or another part of the device in or on which physical sheets to be scanned are placed. The sheets may also be referred to as documents. Furthermore, the sheets may be placed in the scanning input at any time prior to scanning. The device may have scanning functionality, faxing functionality, emailing functionality, and/or printing functionality, among other types of functionality, such that the device may be a multiple-function device (MFD), which is also known as an all-in-one (AIO) device.

For example, all the sheets may be placed in the scanning input at the same time and then the method 100 initiated. As another example, all the sheets may be placed in the scanning input and then the method 100 initiated, and after one or more (but not all) of the sheets have been scanned, at least some of the sheets that have not yet been scanned may be reordered prior to scanning. Similarly, some sheets may be placed in the scanning input at a given time and then the method 100 initiated, and at a later point in time after one or more (but not all) of these sheets have been scanned, additional sheets may be placed in the scanning input, after the last sheet of the first set of sheets. Likewise, some sheets may be placed in the scanning input at a given time and then the method 100 initiated, and at a later point in time after one or more (but not all) of these sheets have been scanned, additional sheets may be placed in the scanning input, in-between two of the sheets of the first set of sheets.

The method 100, prior to scanning, initially sets the current settings governing how sheets are processed (102). These current settings may be default settings of the device itself These current settings may alternatively be specified by a user who initially places some of the sheets in the scanning input. For example, the user may provide these settings at the device itself, or at a computer to which the device is connected. The current settings are initially set in some way so that if the first sheet(s) scanned is not a control sheet that changes the current settings, the method 100 knows how these sheet(s) are to be processed.

The current settings can include destination-oriented settings. Such destination-oriented settings can indicate that scanned sheets are to be printed, are to have electronic versions thereof saved within an electronic file on a storage device like a hard disk drive, are to be faxed to a specified fax number, are to be emailed to a specified email address, and so on. The current settings can also include sheet-oriented and/or scanning-oriented settings. The sheet-oriented and/or scanning-oriented settings can indicate the size of the (subsequently scanned) sheets, such as letter-sized, A4-sized, legal-sized, and so on, as well as whether both sides of the sheets are to be scanned (i.e., duplex mode), or just the front sides of the sheets are to be scanned (i.e., simplex mode), such that processing of these sheets is to be achieved on this same basis. These settings can further indicate whether the (subsequently scanned) sheets are to be scanned in black-and-white, in grayscale, in color, and so on, such that processing of these sheets is to be achieved on this same basis.

Those of ordinary skill within the art can further appreciate that the current settings governing processing of the scanned sheets can include other types of settings, in addition to and/or in lieu of those described here. In general, the current settings, once set, affect processing of all subsequently scanned sheets, until or unless the current settings are subsequently changed by the scanning of a control sheet. Once a control sheet has been scanned, and the current settings changed on the basis thereof, the current settings affect the processing of all subsequently scanned sheets after the control sheet in question. Thus, scanned sheet processing is sequentially performed in relation to the current settings. Modification of the current settings affects subsequently scanned sheets, but not previously scanned sheets, in one embodiment of the invention.

The method 100 performs the following for each sheet placed in the scanning input, in the order in which the sheets have been placed in the scanning input (104). It is noted that this means that parts 106, 108, 110, 112, and/or 114 are performed as sheets are scanned in part 106, in the order in which they are scanned. For example, four sheets A, B, C, and D may originally be placed in the scanning input in the order A, B, C, D. After sheet A has been scanned, two more sheets E and F may be placed in-between sheets C and D, resulting in the new order for the sheets not yet scanned as B, C, E, F, D. Thus, parts 106, 108, 110, 112, and/or 114 in this case are performed for each of these sheets in the order A, B, C, E, F, D, since the two sheets E and F being placed in-between sheets C and D altered the original order A, B, C, D before sheets C and D in particular were able to be scanned.

The method 100 scans the sheet to yield an electronic version of the sheet (106). The electronic version of the sheet is data representing the image that is on the sheet. The electronic version may be stored in JPG format, TIF format, or another type of format, as can be appreciated by those of ordinary skill within the art. It is noted that the sheet is scanned in accordance with the current settings, insofar as whether the sheet is to be simplex or duplex scanned, the size of the sheet, and/or whether the sheet is to be scanned in color, black and white, or grayscale, or all settings that affect the scanning of the sheet.

The method 100 next determines whether the sheet that has been scanned is a control sheet, based on the electronic version of the sheet (108). A control sheet is a special type of sheet that is not process like other sheets are, but rather is used to change the current settings governing sheets, and which thus will affect subsequently scanned sheets after the control sheet. A control sheet may have one or more markings thereon that identify the sheet in question as a control sheet. By analyzing the electronic version of the sheet, the method 100 is able to discern whether or not the sheet that has been scanned is a control sheet. Once it has been determined that a scanned sheet is a control sheet, the method 100 is further able to discern how the current settings are being changed. For instance, the control sheet may have other markings, in indicia-type formats such as bar codes, that indicate how the current settings are to be changed, as can be appreciated by those of ordinary skill within the art.

Therefore, if the current sheet is a control sheet (110), then the method 100 changes the current settings based on the contents of the electronic version of the control sheet (112). The contents of the electronic version of the control sheet mean in this respect that the control sheet has one or more markings, such as in indicate-type formats, that are a priori set to mean that the current settings are to be changed in a specific manner. The current settings that may be changed may be those have been described. In the case where the control sheet indicates that subsequently scanned sheets are to be faxed or emailed, the control sheet itself may indicate the fax number or the email address to which the subsequently scanned sheets are to be faxed or emailed. Specific examples of changes to the current settings by control sheets are described later in the detailed description.

If the current sheet is not a control sheet (110), however, then the method 100 processes the sheet in accordance with the current settings (114). For example, the electronic version of the current sheet may be printed, to yield another hardcopy of the current sheet, in a process commonly known as copying. As another example, the electronic version of the current sheet may be faxed. As a third example, the electronic version of the sheet may be stored within an electronic file on a storage device. As a fourth example, the electronic version of the sheet may be emailed to an email address.

It is noted that the processing performed in part 114 may be achieved for all the scanned sheets, in unison, that are affected by the current settings. For example, there may be five sheets A, B, C, D, and E placed in the scanning input. Sheets A, B, D, and E may not be control sheets, and sheet C may be a control sheet. The current settings may initially be set to provide for faxing of scanned sheets to a given fax number, and sheet C may change the current settings to provide for emailing of subsequently scanned sheets to a given email address.

In this example, the electronic versions of sheets A and B may be “held” so that faxing is not initiated until the (initial) current settings are changed as a result of scanning sheet C. Once sheet C is scanned and recognized as a control sheet, the faxing process of the electronic versions of sheets A and B may be initiated. Likewise, the electronic versions of sheets D and E may not be emailed until after sheet E has been scanned, such that there are no more sheets currently in the scanning input to be scanned. Once sheet E has been scanned, and it is recognized that there are no more sheets currently in the scanning input, an electronic file encompassing the electronic versions of sheets D and E may then be emailed.

Specific examples of performance of the method 100 are now described. Those of ordinary skill within the art can appreciate that embodiments of the invention are not limited to these examples. Rather, the examples are presented in order to explain how various embodiment(s) of the method 100 can operate in relation to specific types of control sheets in particular.

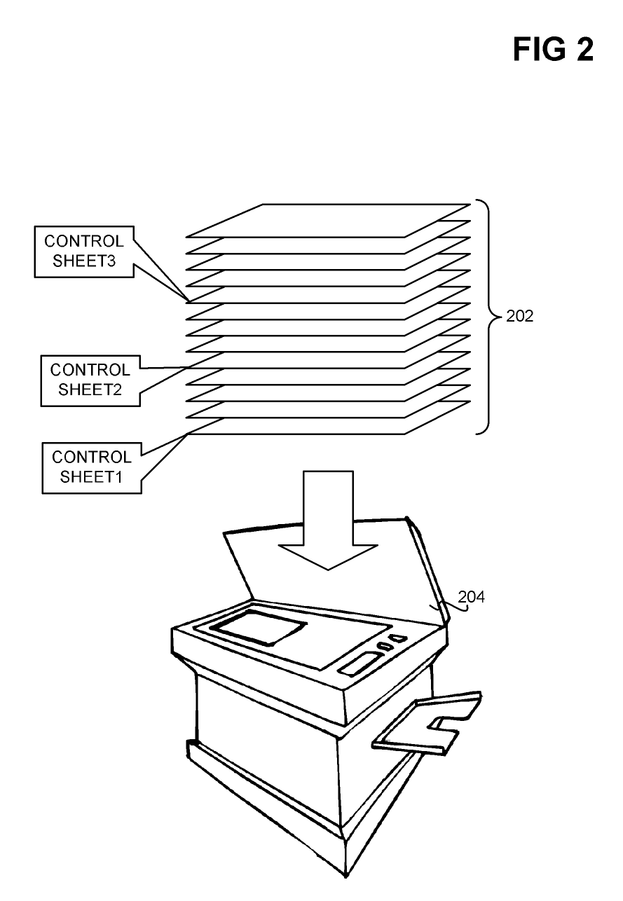

FIG. 2 shows a general example in relation to which the method 100 can be performed, according to an embodiment of the invention. Sheets 202 are placed in the scanning input of a device 204. The first control sheet affects how the three non-control sheets thereafter are scanned and processed, the second control sheet affects how the three non-control sheets thereafter are scanned and processed, and the third control sheet affects how the four non-control sheets thereafter are scanned and processed.

One of the control sheets may indicate that the electronic versions of subsequently scanned non-control sheets are to be printed, until another control sheet is scanned or all sheets have been scanned. One of the control sheets may indicate that electronic versions of subsequently scanned non-control sheets are to be faxed to a fax number specified by the contents of the electronic version of the control sheet, until another control sheet is scanned or all sheets have been scanned. One of the control sheets may indicate that electronic versions of subsequently scanned non-control sheets are to be saved within the same electronic file on a storage device, until another control sheet is scanned or all sheets have been scanned. One of the control sheets may indicate that electronic versions of subsequently scanned non-control sheets are to be emailed within the same electronic file to an email recipient specified by the contents of the electronic version of the control sheet, until another control sheet is scanned or all sheets have been scanned.

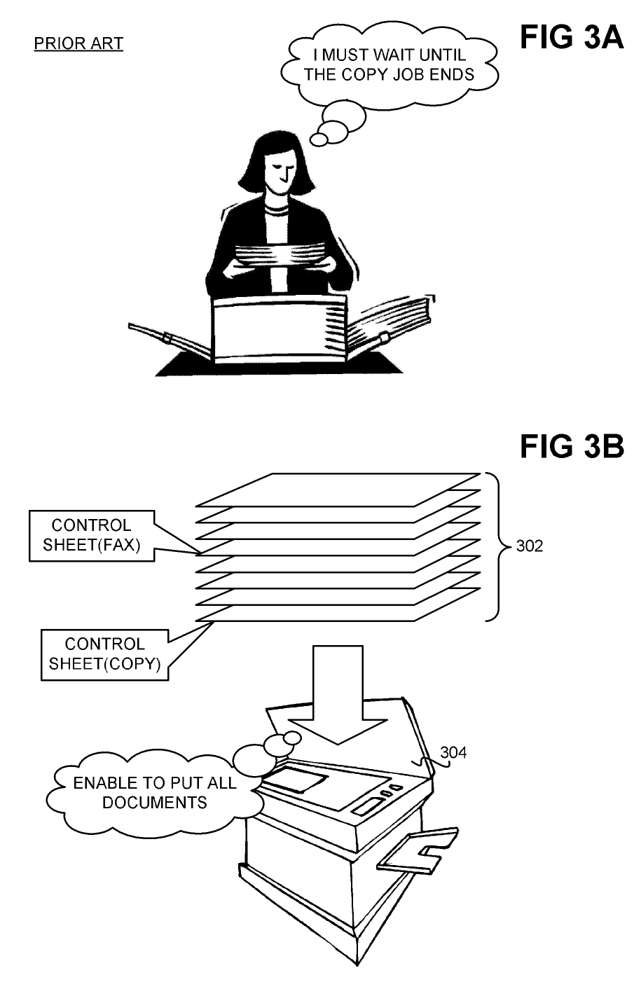

FIGS. 3A and 3B show an example in relation to which the method 100 be performed, in which the user wants to perform both a copy job and a fax job on different sets of sheets, according to an embodiment of the invention. FIG. 3A shows the conventional approach, in which the user has to first place the sheets relating to the copy job on the device, wait for the copy job to finish, and the place the sheets relating to the fax job on the job. By comparison, FIG. 3B shows how the method 100 can make this process more efficient. The user places all sheets 302, relating to both the copy job and the fax job, on the scanning input of a device 304. The sheets 302 include two control sheets. The print job-related control sheet is placed before the sheets that are the subject of the print job, and the fax job-related control sheet is placed before the sheets that are the subject of the fax job.

Once the user has placed all these sheets on the scanning input of the device 304, he or she can walk away. That is, the user does not have to wait for the copy job to finish before placing the sheets for the fax job on the scanning input. Rather, the first control sheet is scanned, which indicates that the subsequently scanned sheets are to be copied. The copy job sheets are thus then scanned and printed. Thereafter, the second control sheet is scanned, which indicates that the subsequently scanned sheets are to be faxed. The fax job sheets are thus then scanned and faxed.

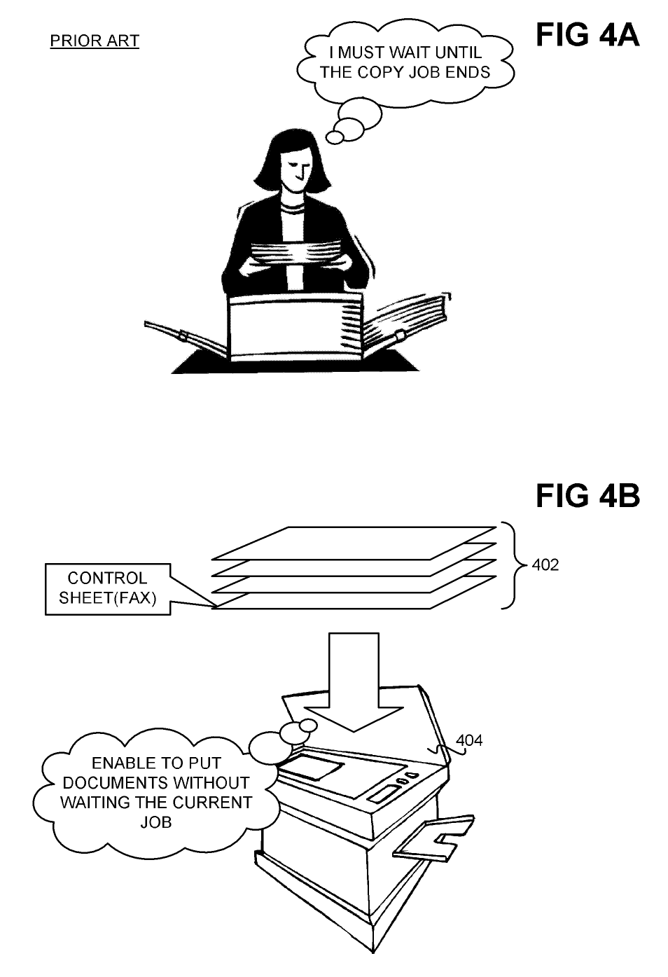

FIGS. 4A and 4B show an example in relation to which the method 100 can be performed, in which a first user has already started a copy job, and a second user wants to start a fax job, according to an embodiment of the invention. FIG. 4A shows the conventional approach, in which the second user has to wait for the copy job started by the first user to be finished before he or she can place the sheets of the fax job on the device. By comparison, FIG. 4B shows how the method 100 can make this process more efficient. The second user walks up to the device 404, and discovers that a copy job has already been started on the device 504 by another (first) user.

Nevertheless, the second user simply places the sheets 402, which include the sheets of the fax job preceded by a fax job-related control sheet, after the last sheet of the first (copy) job already being processed by the device 404. This second user can then walk away from the device 404. Once all the sheets of the first (copy) job have been processed, the device 404 scans the fax job-related control sheet, and changes the current settings so that the subsequently scanned sheets of the sheets 402 are instead faxed as indicated by the control sheet, as desired by the second user.

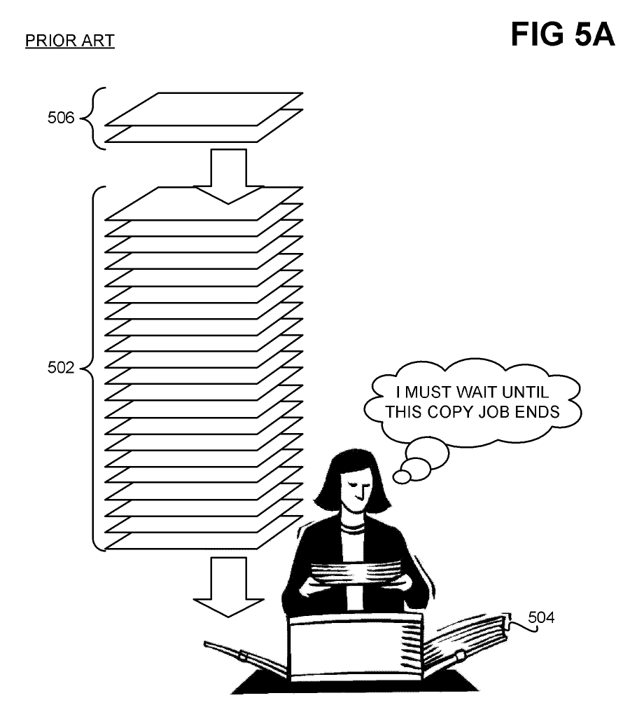

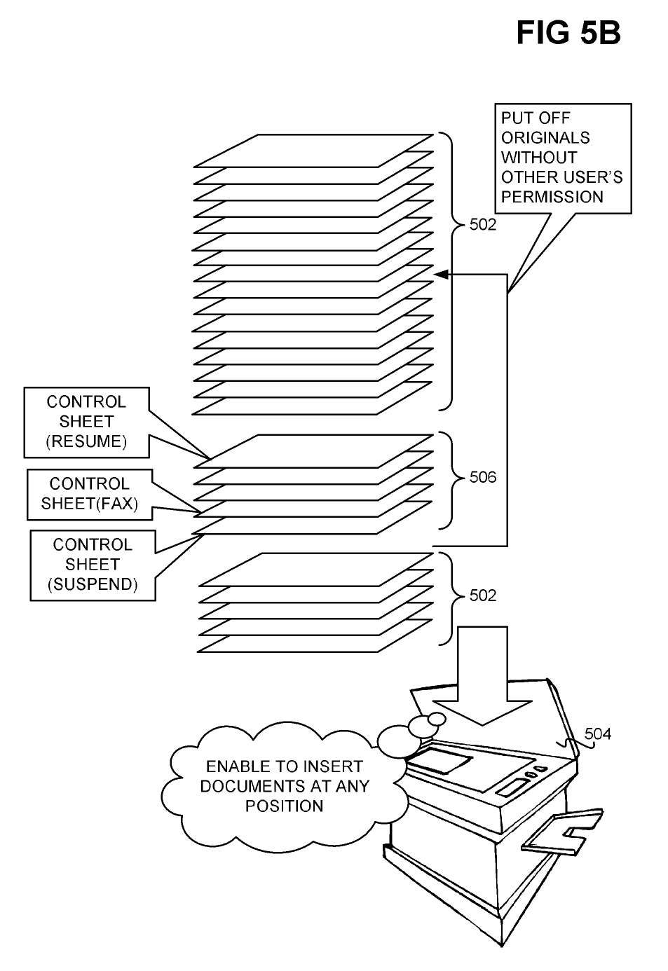

FIGS. 5A and 5B show an example in relation to which the method 100 can be performed, in which a first user has already started a copy job, and a second user wants to interrupt the copy job to start a more urgent fax job, according to an embodiment of the invention. FIG. 5A shows the conventional approach, in which the user has to wait for the copy job of the sheets 502 started by the first user to be finished before he or she can place the fax job of the sheets 506 on the device 504. By comparison, FIG. 5B shows how the method 100 can make this process more efficient. The second user walks up to the device 504, and discovers that a copy job having a relatively large number of sheets 502 has been started on the device 504 by another (first) user.

Because it may take a long time for the copy job to finish, the process described in relation to FIG. 4B may not be desired to be performed. Therefore, instead the second user places the sheets 506, which include the sheets of the fax job, preceded by a fax job and interruption-related control sheet and appended by a resume previous job-related control sheet, in-between two of the sheets 502 of the first job. The second user can then walk away from the device 504.

At some point, the device 504 scans the fax job and interruption-related control sheet of the sheets 506. This sheet indicates that the current settings, relating to the print job, are to be saved as saved settings for later retrieval, and that subsequently scanned non-control sheets are to be processed in accordance with changed settings, specifically relating to the fax job. Therefore, the remainder of the non-control sheets of the sheets 506 are scanned, and faxed in accordance with these changed settings.

Thereafter, the device 504 scans the resume previous job-related control sheet of the sheets 506. This sheet indicates that the current settings are to be reverted back to the saved settings previously saved, and that the subsequently scanned non-control sheets are to be processed in accordance with these previously saved settings. Thus, the remainder of the non-control sheets of the sheets 502 are scanned and copied, as previous sheets of the sheets 502 were scanned and copied.

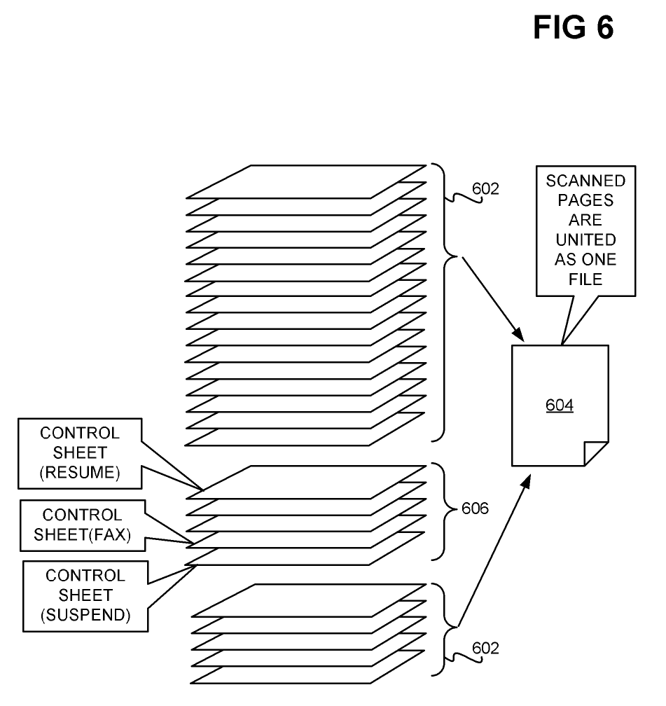

FIG. 6 shows an example in relation to which the method 100 can be performed, in which a first user has already started a job, and a second user wants to interrupt the job to start a more urgent fax job, according to an embodiment of the invention. The first user has placed sheets 602 in the scanning input of a device. The current settings controlling the processing of the sheets 602 specify that the electronic versions of the sheets 602 are to be stored in an electronic file 604, for emailing or another purpose. The second user walks up to the device, and discovers that this job has a relatively large number of sheets 602. The second user wants to interrupt this job so that he or she is able to process a more urgent fax job including the sheets 606.

As in FIG. 5B, the second user places the sheets 606, which include the sheets of the fax job, preceded by a fax job and interruption-related control sheet and appended by a resume previous job-related control sheet, in-between two of the sheets 602 of the first job. The second user then walks away from the device. At some point, the device 504 scans the fax job and interruption-related control sheet of the sheets 606. This sheet indicates that the current settings, relating to the original job, are to be saved as saved settings for later retrieval, and that subsequently scanned non-control sheets are to be processed in accordance with change settings, specifically relating to the fax job. Therefore, the remainder of the non-control sheets of the sheets 606 are scanned, and faxed in accordance with these changed settings.

Thereafter, the device scans the resume previous job-related control sheet of the sheets 606. This sheet indicates that the current settings are to be reverted back to the saved settings previously saved, and that the subsequently scanned non-control sheets are to be processed in accordance with these previously saved settings. Thus, the remainder of the non-control sheets of the sheets 602 are scanned and stored within the electronic file 604, as the previous sheets of the sheets 602 were.

It is noted that electronic versions of all of the sheets 602 are stored in the same electronic file 604, even though scanning of the sheets 602 was interrupted by the fax job encompassing the sheets 606. This is advantageous, because the first user intended to have all the sheets 602 stored in the same electronic file 604. Thus, even though scanning of the sheets 602 is interrupted by a fax job, all of the sheets 602 are nevertheless still stored in the same electronic file 604, as opposed to being stored in two separate electronic files, for instance.

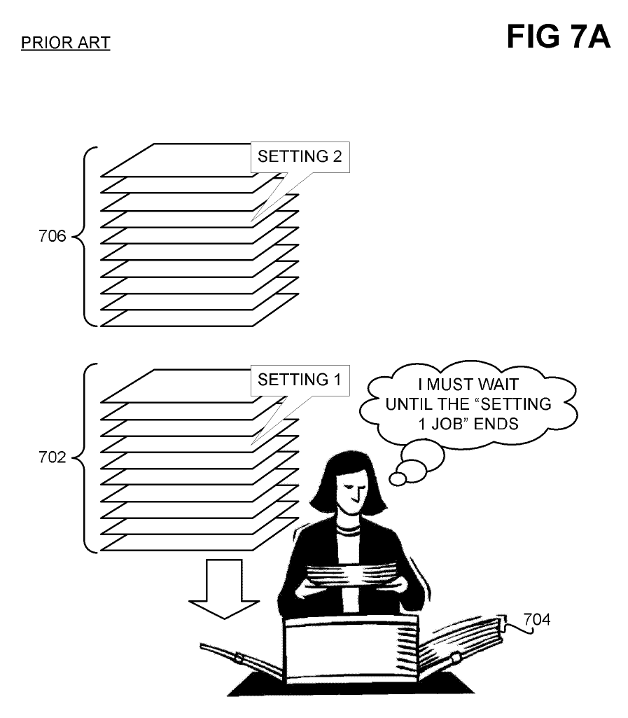

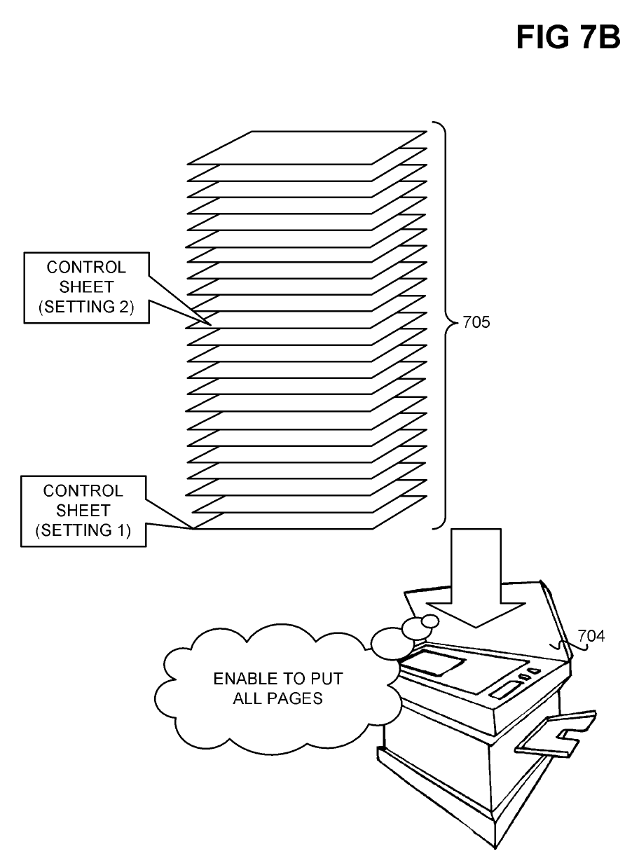

FIGS. 7A and 7B show an example in relation to which the method 100 can be performed, in which a user wants to scan sheets 702 with a first set of settings, and sheets 706 with a second set of settings, according to an embodiment of the invention. FIG. 7A shows the conventional approach, in which the user first has to specify the first set of settings, and wait for the sheets 702 to be scanned in accordance with these settings before specifying the second set of settings governing scanning of the sheets 706. That is, the user has to wait to place the sheets 704 on the scanning input of the device 704 until all the sheets 702 have been scanned. The first set of settings may be that the sheets 702 are to be scanned in color, for example, whereas the second set of settings may be that the sheets 706 are to be scanned in black and white.

By comparison, FIG. 7B shows how the method 100 can make this process more efficient. The user walks up to the device 704, and places on the scanning input of the device 704 all the sheets 704, which encompass the sheets 702 and the sheets 706. The first sheet is a first control sheet that specifies that the first set of settings is to govern scanning and processing of subsequently scanned sheets. The second control sheet is inserted between the last sheet of the sheets 702 and the first sheet of the sheets 706 within the sheets 705, and specifies that the second set of settings is to govern scanning and processing of subsequently scanned sheets. As such, the sheets 702 are scanned in color (for instance), and the sheets 706 are scanned in black and white (for instance), even though the user has placed all the sheets 705 on the device 704 at the same time, and may have walked away, such that the user does not have to wait for processing of the sheets 702 to have finished before placing the sheets 706 on the device 704.

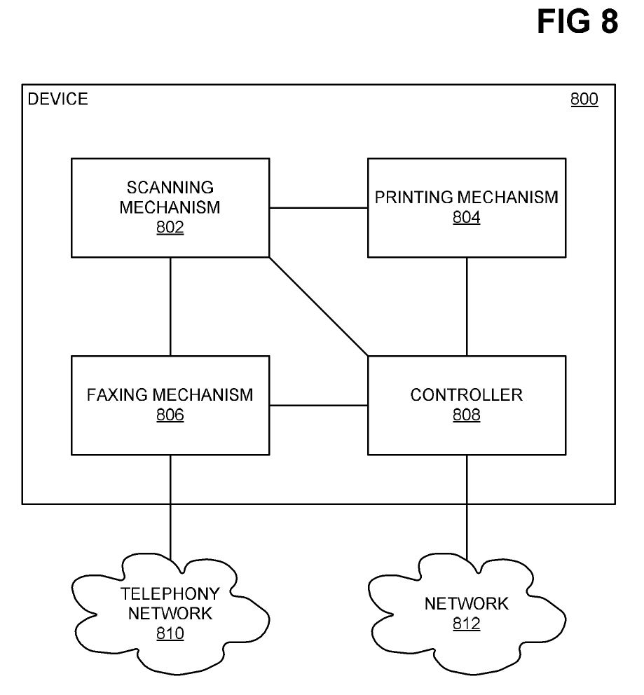

FIG. 8 shows a rudimentary MFD 800, according to an embodiment of the invention. The MFD 800 can include a scanning mechanism 802, a printing mechanism 804, a faxing mechanism 806, and a controller 808. As can be appreciated by those of ordinary skill within the art, the MFD 800 may include other components, in addition to and/or in lieu of those depicted in FIG. 8. Each of the mechanisms 802, 804, and 806, may be implemented in hardware or a combination of software and hardware. The controller 808 may be implemented, in hardware, software, or a combination of software and hardware.

The scanning mechanism 802 is capable of scanning sheets to yield electronic versions of these sheets. The scanning mechanism 802 may perform part 106 of the method 100. The scanning mechanism 802 may be or include an optical scanning mechanism, including a contact image sensor (CIS), a charge-coupled device (CCD), a complementary metal-oxide semiconductor (CMOS) scanner, or another type of optical scanning mechanical.

The printing mechanism 804 is capable of printing the electronic versions of the sheets, to yield additional hardcopies, or copies of the sheets. The printing mechanism 804 may be able to print in full color, in grayscale, and/or in black and white. The printing mechanism 804 may be a laser-printing mechanism, an inkjet-printing mechanism, or another type of printing mechanism.

The faxing mechanism 806 is communicatively connected to a telephony network 810, and is capable of transmitting faxes encompassing the electronic versions of the sheets. The faxing mechanism 806 may be a part of a modem in one embodiment. The telephony network 810 may be a public switch telephony network (PSTN) in one embodiment, whereas in another embodiment, it may be an Internet Protocol (IP)-addressable network, such as or including the Internet, intranets, extranets, and so on.

The controller 808 performs parts 108, 110, 112, and 114 of the method 100 as have been described, and can also perform part 102 of the method 100. Where electronic versions of the sheets can be emailed to email recipients, the controller 808 may be communicatively connected to a network 812. The network 812 may be one or more of: a wireless network, a wired network, a mobile telephony network, the Internet, an intranet, an extranet, a local-area network (LAN), and a wide-area network (WAN), among other types of networks.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof

We claim:

1. A method comprising:
setting current settings governing processing of a plurality of sheets that have been placed in a scanning input of a device having at least scanning functionality and printing functionality;
for each sheet of the plurality of sheets that have been placed in the scanning input, in order in which the plurality of sheets have been placed in the scanning input,
scanning the sheet to yield an electronic version of the sheet;
determining whether the sheet is a control sheet, based on the electronic version of the sheet;
where the sheet is a control sheet,
changing one or more of the current settings based on contents of the electronic version of the control sheet, comprising one or more first actions selected from a group of first actions comprising:
indicating that electronic versions of subsequently scanned non-control sheets of the plurality of sheets are to be printed;
indicating that the electronic versions of the subsequently scanned non-control sheets of the plurality of sheets are to be faxed to a fax number specified by the contents of the electronic version of the control sheet;
indicating that the current settings are to be saved as saved settings for later retrieval and that the subsequently scanned non-control sheets of the plurality of sheets are to be processed in accordance with changed settings specified by the contents of the electronic version of the control sheet;
indicating that the current settings are to be reverted back to the saved settings previously saved and that the subsequently scanned non-control sheets of the plurality of sheets are to be processed in accordance with the saved settings previously saved; and,
where the sheet is not a control sheet,
processing the sheet in accordance with the current settings based on the electronic version of the sheet, comprising one or more second actions selected from a group of second actions comprising: printing the electronic version of the sheet, faxing the electronic version of the sheet, and storing the electronic version of the sheet within an electronic file on a storage device.

2. The method of claim 1, wherein the device further has faxing functionality.

3. The method of claim 1, wherein all of the plurality of sheets are placed in the scanning input at the same time.

4. The method of claim 1, wherein the plurality of sheets comprise a first set of sheets and a second set of sheets, the first set of sheets placed in the scanning input first in time, and the second set of sheets placed in the scanning input later in time after a last sheet of the first set of sheets, the second set of sheets placed in the scanning input after at least one sheet of the first set of sheets has already been scanned.

5. The method of claim 1, wherein the plurality of sheets comprise a first set of sheets and a second set of sheets, the first set of sheets placed in the scanning input first in time, and the second set of sheets placed in the scanning input later in time in-between two sheets of the first set of sheets, the second set of sheets placed in the scanning input after at least one sheet of the first set of sheets has already been scanned.

6. The method of claim 1, wherein changing the one or more of the current settings based on contents of the electronic version of the control sheet comprises indicating that the electronic versions of the subsequently scanned non-control sheets of the plurality of sheets are to be printed.

7. The method of claim 1, wherein changing the one or more of the current settings based on contents of the electronic version of the control sheet comprises indicating that the electronic versions of the subsequently scanned non-control sheets of the plurality of sheets are to be faxed to the fax number specified by the contents of the electronic version of the control sheet.

8. The method of claim 1, wherein changing the one or more of the current settings based on contents of the electronic version of the control sheet comprises indicating that the current settings are to be saved as saved settings for later retrieval and that the subsequently scanned non-control sheets of the plurality of sheets are to be processed in accordance with the changed settings specified by the contents of the electronic version of the control sheet.

9. The method of claim 1, wherein changing the one or more of the current settings based on contents of the electronic version of the control sheet comprises indicating that the current settings are to be reverted back to the saved settings previously saved and that the subsequently scanned non-control sheets of the plurality of sheets are to be processed in accordance with the saved settings previously saved.

10. The method of claim 1, wherein the group of first actions further comprises indicating that the electronic versions of the subsequently scanned non-control sheets of the plurality of sheets are to be saved within a same electronic file on the storage device.

11. The method of claim 1, wherein the group of first actions further comprises indicating that the electronic versions of the subsequently scanned non-control sheets of the plurality of sheets are to be emailed within a same electronic file to an email recipient specified by the contents of the electronic version of the control sheet.

12. The method of claim 1, wherein the group of first actions further comprises indicating that the subsequently scanned non-control sheets are to be scanned in accordance with one or more of: color, grayscale, black and white, letter-size pages, legal-sized pages, A4-sized pages, simplex pages, and duplex pages, such that processing of the subsequently scanned non-control sheets is to be achieved on a same basis.

13. The method of claim 1, wherein the group of second actions further comprises emailing the electronic version of the sheet as part of an electronic file.

14. A device comprising:
a scanning mechanism capable of receiving a plurality of sheets and scanning the sheets in order in which they have been placed relative to the scanning mechanism, each sheet scanned to yield an electronic version of the sheet;
a printing mechanism; and,
a controller to, for each sheet that has been scanned by the scanning mechanism:
determine whether the sheet is a control sheet, based on the electronic version of the sheet;
where the sheet is a control sheet,
change one or more current settings governing processing of the plurality of the sheets, based on contents of the electronic version of the control sheet, including one or more of:
indicating that electronic versions of subsequently scanned non-control sheets of the plurality of sheets are to be printed by the printing mechanism;
indicating that the current settings are to be saved as saved settings for later retrieval and that the subsequently scanned non-control sheets of the plurality of sheets are to be processed in accordance with changed settings specified by the contents of the electronic version of the control sheet;
indicating that the current settings are to be reverted back to the saved settings previously saved and that the subsequently scanned non-control sheets of the plurality of sheets are to be processed in accordance with the saved settings previously saved; and,
where the sheet is not a control sheet,
process the sheet in accordance with the current settings based on the electronic version of the sheet, including one or more of, printing the electronic version of the sheet using the printing mechanism, and storing the electronic version of the sheet within an electronic file on a storage device.

15. The device of claim 14, wherein the device comprises a faxing mechanism,
wherein the controller is to change the one or more current settings governing processing of the plurality of sheets as further including indicating that the electronic versions of the subsequently scanned non-control sheets of the plurality of sheets are to be faxed to a fax number specified by the contents of the electronic version of the control sheet, by the faxing mechanism, and
wherein the controller is process the sheet in accordance with the current settings based on the electronic version of the sheet as further including faxing the electronic version of the sheet using the faxing mechanism.

16. The device of claim 14, wherein the controller is to change the one or more current settings governing processing of the plurality of sheets as further including indicating that the electronic versions of the subsequently scanned non-control sheets of the plurality of sheets are to be saved within a same electronic file on the storage device.

17. The device of claim 14, wherein the controller is to change the one or more current settings governing processing of the plurality of sheets as further including indicating that the electronic versions of the subsequently scanned non-control sheets of the plurality of sheets are to be emailed within a same electronic file to an email recipient specified by the contents of the electronic version of the control sheet, and
wherein the controller is process the sheet in accordance with the current settings based on the electronic version of the sheet as further including emailing the electronic version of the sheet as part of an electronic file.

18. A recordable data storage medium having one or more computer programs stored thereon to perform a method comprising:
setting current settings governing processing of a plurality of sheets that have been placed in a scanning input of a device having at least scanning functionality and printing functionality;
for each sheet of the plurality of sheets that have been placed in the scanning input, in order in which the plurality of sheets have been placed in the scanning input,
scanning the sheet to yield an electronic version of the sheet;
determining whether the sheet is a control sheet, based on the electronic version of the sheet;
where the sheet is a control sheet,
changing one or more of the current settings based on contents of the electronic version of the control sheet, comprising one or more first actions selected from a group of first actions comprising:
indicating that the current settings are to be saved as saved settings for later retrieval and that the subsequently scanned non-control sheets of the plurality of sheets are to be processed in accordance with changed settings specified by the contents of the electronic version of the control sheet;
indicating that the current settings are to be reverted back to the saved settings previously saved and that the subsequently scanned non-control sheets of the plurality of sheets are to be processed in accordance with the saved settings previously saved; and,
where the sheet is not a control sheet,
processing the sheet in accordance with the current settings based on the electronic version of the sheet.

19. The recordable data storage medium of claim 18, wherein the group of first actions further comprises one or more of:
indicating that electronic versions of subsequently scanned non-control sheets of the plurality of sheets are to be printed; and,
indicating that the electronic versions of the subsequently scanned non-control sheets of the plurality of sheets are to be faxed to a fax number specified by the contents of the electronic version of the control sheet

20. The recordable data storage medium of claim 18, wherein the group of first actions further comprises one or more of:
indicating that the electronic versions of the subsequently scanned non-control sheets of the plurality of sheets are to be saved within a same electronic file on the storage device; and,
indicating that the electronic versions of the subsequently scanned non-control sheets of the plurality of sheets are to be emailed within a same electronic file to an email recipient specified by the contents of the electronic version of the control sheet.
